(19) United States
(12) Patent Application Publication
(10) Pub. No.: US 2003/0125913 A1
(43) Pub. Date: Jul. 3, 2003

(54) Linear time invariant system simulation with iterative model

(76) Inventor: Tan Du, Plano, TX (US)

Correspondence Address: TEXAS INSTRUMENTS INCORPORATED, P O BOX 655474, M/S 3999, DALLAS, TX, 75265

(21) Appl. No.: 10/242,028

(22) Filed: Sep. 11, 2002

Related U.S. Application Data
(60) Provisional application No. 60/344,202, filed on Dec. 28, 2001.

(51) Int. Cl. G06F 17/10

(52) U.S. Cl. 703/2

(57) ABSTRACT

Disclosed are systems, methods and algorithms for simulating a Linear Time Invariant (LTI) system, such as a circuit, using an iterative model. A settle time is determined for a LTI system. Standard step response data is collected reflecting the step response of the system for a period equal to the settle time. A particular section of standard step response data is then used for modeling the LTI system for an arbitrary input and providing simulated output results.

### RELATED APPLICATIONS

This application claims priority based on Provisional Patent Application 60/344,202, filed Dec. 28, 2001. This application is also related to patent application Ser. No. ______, filed on ______, 2002. This application and the aforementioned related application have at least one common inventor and are assigned to the same entity.

### TECHNICAL FIELD

The invention relates to Linear Time Invariant (LTI) system simulation using iterative model and minimal data set. Method, system and software implementations of the invention are disclosed. The simulation model uses the standard step response of a LTI system to reconstruct the system model in limited steps in time-domain, without prior knowledge of frequency domain information (zero/poles and gain).

### BACKGROUND

A challenge that every semiconductor company faces is how to shorten the manufacturing cycle in order to meet increasing customer demand for quick delivery of IC chips. Apart from the fabrication process, this requires that design specifications be fully checked before and during circuit design. Accordingly, it is desirable to simulate schematic designs not only at the block-level, but also at the whole-chip level for the purpose of attaining first-pass success and reducing turn-over. It is difficult to simulate a large chip with a large amount of analog circuitry because current Electronics Design Automation (EDA) tools are slow in transistor-level simulation. Due to the expense associated with manufacturing, for efficiency the test device and code development must be fully debugged and tested before actual silicon comes out. A lack of chip block models acceptable for current test and characterization platforms make the early debugging of code and test devices difficult.

Other problems arise in attempting to integrate simulation methods used in different phases of the development process. It is not uncommon for resources to be wasted when different elements of the process, e.g. system, design, characterization, or test, use different test vectors, each using different models for the same blocks. Models of devices are often written in languages specific to a platform and incompatible with other platforms. Also, most modeling tools are not transparent to designers, limiting flexibility to adapt to new designs. These problems are particularly acute when the chip is of a mixed-signal type, where the analog part of the chip is generally more difficult to simulate than the digital portion.

Most analog blocks of an IC are LTI systems within their operational range. The most widely used model for a LTI system is a transfer function H(S). Usually a mix-signal EDA tool provides commands for such a model. Examples include available tools such as: MAST (a registered trademark of Analogy, Inc.); VerilogA; Verilog-AMS (Verilog is a registered trademark of Gateway Design Automation Corp.); and VHDL-AMS. However, these EDA tools usually cannot work cross-platform, and the models in these tools are not mutually transferable. Whatever a model looks like in the frequency domain, the end code of the model is still needed to run in time-domain by EDA simulation engines. Both models and engines are not transparent to users.

An all-purpose model and simulator for LTI systems would be highly useful and advantageous in the arts. A solution to the above problems would provide an “all purpose” method that uses a common computer language for modeling analog and digital LTI systems for simulation. The ability of such a simulation model to be used across multiple platforms between design, system, characterization and test would provide additional useful advantages.

### SUMMARY OF THE INVENTION

In general, the invention provides for the efficient simulation of a LTI system by using iterative modeling requiring fewer data points than techniques familiar in the arts. The preferred embodiments of the invention may be used across multiple platforms for system design, characterization and test.

According to one aspect of the invention, a method of constructing a simulation of a linear time invariant (LTI) system is presented. A step of providing a first step input, x₀(t), to the LTI system for producing a first output, y₀(t) is used for measuring a settle time, Tₛₑₜₜₗₑ. In another step, a second step input, x₁(t), is provided to the LTI system for measuring the second input, x₁(t), and the second output, y₁(t), for a period consisting of the settle time, Tₛₑₜₜₗₑ. The ratio of the second output to the second input, y₁(t):x₁(t), is the standard step response. The particular part of this ratio is saved as the data for modeling the LTI system. Effective use of this data provides system simulation result for an arbitrary input.

According to a further aspect of the invention, a step of selecting a tolerance limit for error detection is provided in the modeling step.

According to another aspect of the invention, the step of measuring the second input, x₁(t), and the second output, y₁(t), for a period consisting of the settle time also includes the step of taking samples at time intervals defined by the quotient of the settle time over a number selected from system reconstruction accuracy.

According to still another aspect of the invention, the step of modeling the LTI system with the standard step response data uses the relationship:

$$y ( {t}_{k} ) = y ( {t}_{k - 1} ) + Δ {x}_{k - 1} p ( {t}_{k} - {t}_{k - 1} ) + {\sum }_{j = n}^{k - 2} Δ {x}_{j} [ p ( {t}_{k} - {t}_{j} ) - p ( {t}_{k - 1} - {t}_{j} ) ]$$

wherein when j<n the absolute value of [p(tₖ−tⱼ)−p(tₖ₋₁−tⱼ)] is smaller than a tolerance threshold,

According to another aspect of the invention, the step of modeling the LTI system using the standard step response data further comprises the step of using the relationship: y(tₖ)=y(tₖ₋₁)+a₁Δxₖ₋₁+a₂Δxₖ₋₂+ . . . +a_{M}Δx_{k-M}, where the sample step length is described by the quotient of a time constant associated with the LTI system multiplied by a value selected from within a range.

According to additional aspects of the invention, systems for constructing a simulation of a linear time invariant (LTI) circuit are described. The systems comprise means for determining a settle time of the LTI circuit, for measuring a step response, for storing standard step response data and means for modeling the LTI circuit using the standard step response data and means for providing LTI circuit simulation results.

According to one aspect of the system of the invention, the standard step response data comprises the ratio of the LTI circuit output, y₁(t), to the LTI circuit input, x₁(t).

According to another aspect of the invention, an algorithm is provided for modeling a linear time invariant (LTI) circuit. The algorithm includes a sequence of actions for providing a first step input, x₀(t), to the LTI circuit for producing a first output, y₀(t) and measuring a settle time, Tₛₑₜₜₗₑ, of approximately the time interval within which the LTI circuit reaches a steady state. A second step input, x₁(t), is used to produce a second output y₁(t) for measuring for a duration approximately equal to the settle time, Tₛₑₜₜₗₑ. The particular part of the ratio of the second output to the second input is saved as standard step response data, and the LTI circuit is modeled using the standard step response data according to a pre-selected formula.

According to one aspect of the invention, the modeling formula used in the algorithm is:

$$y ( {t}_{k} ) = y ( {t}_{k - 1} ) + Δ {x}_{k - 1} p ( {t}_{k} - {t}_{k - 1} ) + {\sum }_{j = n}^{k - 2} Δ {x}_{j} [ p ( {t}_{k} - {t}_{j} ) - p ( {t}_{k - 1} - {t}_{j} ) ]$$

wherein when j<n the absolute value of [p(tₖ−tⱼ)−p(tₖ₋₁−tⱼ)] is smaller than a tolerance threshold.

According to still another aspect of the invention, the model of the algorithm further includes the setting of a tolerance limit for error detection.

According to yet another aspect of the invention, the modeling formula: y(tₖ)=y(tₖ₋₁)+a₁Δxₖ₋₁+a₂Δxₖ₋₂+ . . . +a_{M}Δx_{k-M} is used, where the sample length is a time constant associated with the LTI circuit, and X consists of selected constant multiplied by a value selected from within a range.

The invention provides numerous technical advantages including but not limited to simulation modeling that uses a common computer language for modeling and simulating analog and digital single input/output and multiple input/output LTI systems. The simulation model provides the capability of reducing the number of data points and computations required for an effective simulation, leading to savings in time and computation resources. The simulation model can be used across multiple platforms between design, system, characterization and test, providing advantages in terms of efficiency and accuracy throughout the design, development and production of LTI systems such as electronic circuits.

### BRIEF DESCRIPTION OF THE FIGURES

FIG. 1 shows an example of the prior art method of using a unity step function to model a linear time invariant system.

FIG. 2 provides a conceptual view of the settle time, Tₛₑₜₜₗₑ, of a simulation model according to the invention;

FIG. 3 is a block diagram showing an example of a system architecture for implementation of the invention;

FIG. 4 is a process flow diagram depicting an example of the steps of the invention;

FIG. 5 is a schematic diagram showing an example of the use of the invention to simulate a circuit block as a “black-box”;

FIG. 6 is an example of a graphical representation of a standard step response of the black box system of FIG. 5 for use with the invention;

FIG. 7 is an example of a graphical representation of a simulation of the black box circuit of FIG. 5 using the invention with an arbitrary input; and

FIG. 8 is a graphical representation of a transistor-level simulation of the circuit of FIG. 5 using the same arbitrary input for comparison with the simulation result of the invention shown in FIG. 7.

### DETAILED DESCRIPTION OF PREFERRED EMBODIMENTS

The method, system, and software of the invention is aimed at solving some plaguing problems in the semiconductor industry, and may have wide applications to other areas as well. The described embodiments show examples of replacing a transistor-level amp with an iterative model simulation. The result is comparable to that from a standard Spice (trademark of Intusoft, Inc.) simulation using transistor-level simulation. Of course, the examples herein are illustrative only. Many alternative embodiments are possible. From the Examples shown, the broader scope of application of the concepts of the invention should be apparent to those skilled in the arts.

The invention will be better understood in light of the following detailed description and examples. It has been determined that a model in time domain is more suitable for use with multiple platforms. This leads us to consider well-known convolution method in Equation (1):

$$y ( t ) = {\int }_{0}^{t} h ( τ ) \times ( t - τ ) ⅆ τ , \qquad Eq . 1$$

where h(t) is the impulse response of system H(S), x(t) the input and y(t) the output. However, the impulse requires infinite amplitude and zero time-duration, and thus direct convolution must be adapted for practical engineering applications.

The integral of an impulse is a step function, and an arbitrary input waveform x(t) can be viewed as the combination of infinite step signals with various amplitudes (since partition interval may not be fixed), thus in Equation (2):

$$x ( t ) = {\sum }_{j = 0}^{k - 1} Δ {x}_{j} u ( t - {t}_{j} ) , \qquad Eq . 2$$

when k approaches infinity and (tₖ₋₁<t), where u(t) is the unity amplitude step function, and Δxⱼ the actual amplitude or gain to the jth u(t).

FIG. 1 (prior art) is a graph showing the concept of partitioning an arbitrary system input signal into a series of step functions. It is known to partition an arbitrary linear time invariant system input 1 into smaller pieces 3 represented by step functions. As shown on the vertical axis 5, the changes in the signal represented by Δx are measured at arbitrary time intervals as indicated by the horizontal t-axis 7. It is known to use such a step function model to simulate a system for a selected time period, e.g. time period T 9. Thus, as described with reference to Equation 2, those skilled in the arts will readily perceive that the signal x(t) 1 may be approximated by a series of step signals 3. Of course, the more step signals used, the closer the approximation.

If the response of system H(S) to the unity step input u(t) is known to be p(t), according the property of a LTI system, the system output can be written according to Equation (3):

$$y ( t ) = {\sum }_{j = 0}^{k - 1} Δ {x}_{j} p ( t - {t}_{j} ) , \qquad Eq . 3$$

when k approaches infinity and (tₖ₋₁<t).

Let us assume the current time is t=tₖ, Equation (2) can be expressed as in Equation (4):

$$y ( {t}_{k} ) = {\sum }_{j = 0}^{k - 1} Δ {x}_{j} p ( {t}_{k} - {t}_{j} ) , \qquad Eq . 4$$

when k approaches infinity and (tₖ₋₁<tₖ).

Still, the form of Equation (4) cannot be used directly for practical implementation, due to the infinite number of terms in the summation function. However, if we consider the expression of y(tₖ₋₁) and get the difference between it and y(tₖ), it is not difficult to express y(tₖ) in terms of y(tₖ₋₁), as shown in Equation (5):

$$y ( {t}_{k} ) = y ( {t}_{k - 1} ) + Δ {x}_{k - 1} p ( {t}_{k} - {t}_{k - 1} ) + {\sum }_{j = 0}^{k - 2} Δ {x}_{j} [ p ( {t}_{k} - {t}_{j} ) - p ( {t}_{k - 1} - {t}_{j} ) ] , \qquad Eq . 5$$

when (tₖ₋₁<tₖ), and

k→∞ Expression (6).

Note it is the condition of Expression (6), k→∞, that makes the equals sign “=” hold true in equations from (2) to (5). Expression (6) is equivalent to letting the maximum sampling length approach zero, making the modeled signal a theoretically ideal reproduction of the sampled signal.

This approach makes the number of terms in the summation term of Equation (4) become infinite. Even if in the engineering sense we make Tₛ very small rather than extremely near zero, this number will still overload the computation power of any computation device as k increases, making the y(tₖ) calculation practically impossible. However, if we look into the terms in the summation of Equation (4) carefully, we can see that the expression, [p(tₖ−tⱼ)−p(tₖ₋₁−tⱼ)] is the “one step increment” of the standard unity step response delayed by the time of tⱼ. As long as the system is stable, which means the transient triggered at tⱼ will settle down eventually, the “one step increment” will be approaching zero after a multiple of major time constants. For instance, for a first order system, the error will be less than 0.2% after 6Tₑ. It is similar for the higher order system, where Tₑ is the major time constant. Therefore, the “one step increment” can be ignored without losing the accuracy required in engineering applications.

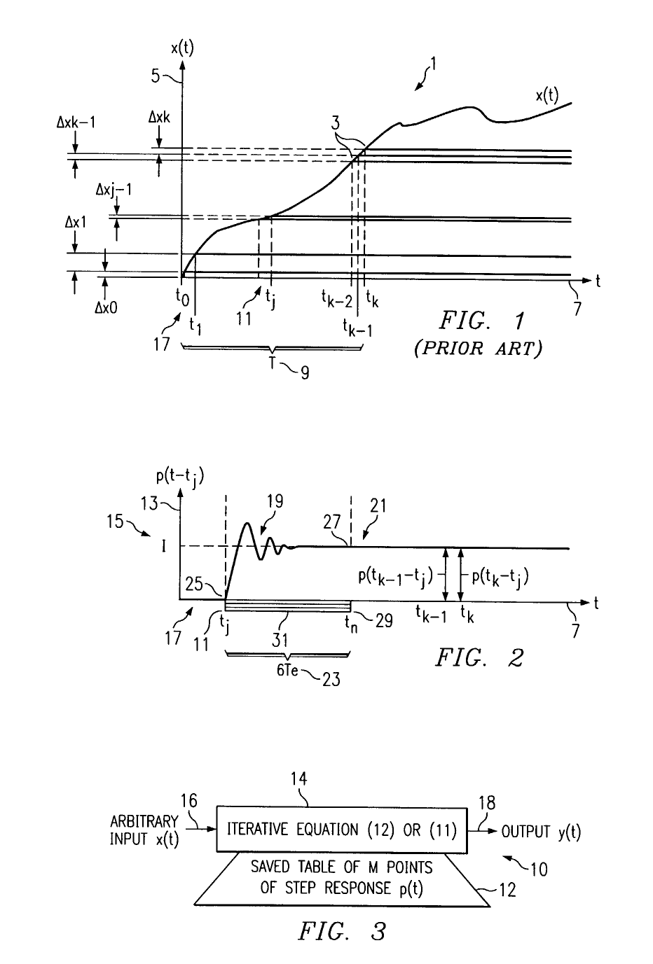

This can be graphically explained with reference to FIG. 2, where p(t-tⱼ) 13 is represented on the vertical-axis and the unity step response 15 caused by the step-input at point tⱼ 11, is shown. There are k such similar curves which may be so represented, as indicated by Equation (5). With the understanding that initial step input 17 may be ignored for the purposes of the obtaining the output signal y(t) 19, after the system settles down 21. Typically the system settled down after about (6˜12)Tₑ, 23, where Tₑ represents a major time-constant for the particular system.

As can be seen by the signal 19, with respect to the t-axis 7, the significant variations in the signal 19 have settled down well before time tₙ 29, thus the time period from tⱼ 11 until tₙ 29, indicated by six time constants, or 6Tₑ in this particular illustration, is a preferred “settle time” 23 for the methods and systems for modeling a first order linear time invariant system. In this way, computations for the period 21 after the settle time 23 may be avoided.

Thus, eliminated the unneeded computations, Equation (5) can be readily simplified to Equation (7):

$$y ( {t}_{k} ) = y ( {t}_{k - 1} ) + Δ {x}_{k - 1} p ( {t}_{k} - {t}_{k - 1} ) + {\sum }_{j = n}^{k - 2} Δ {x}_{j} [ p ( {t}_{k} - {t}_{j} ) - p ( {t}_{k - 1} - {t}_{j} ) ] , \qquad Eq . 7$$

when sample length, Tₛ→0, and (tₖ₋₁−tₙ)<6Tₑ. Note that this results in a great reduction of computation load, though there may still be many sampling points for implementation because of the requirement discussed above wherein the sample lengths, Tₛ (not shown in FIG. 2) would ideally approach zero.

Only data within the unsettled time period carries system information. Referring to Equation (7) and FIG. 2, as there are only (k-2-n) points in the summation, which are all in the range of 6Tₑ, 23 indicated by the shaded area 31, the implementation challenge is how to select the sample step Tₛ so that discrete samples can be used to represent the key features of the original analog LTI system. This looks more like a curve-fitting problem than a sampling/restoring problem. Naturally, if a variable sample size Tₛ is to be used, in the area where the curve has more changes (e.g., shaded area 31), it is desirable to have more sample points than during the time period when the curve has less changes.

If Tₛ is fixed and the number M sample points is desired, there should exist relationships as shown in Equations (8) and (9):

MTₛ=6Tₑ, Eq. 8;

Tₛ=6Tₑ/M, Eq. 9.

From experience it has been found that, for the normal second order dynamic system, 20˜200 points are usually sufficient to duplicate the system to a good accuracy. The larger the M, the higher the accuracy the simulation can attain, because of reduced partition (or slice) error of using a step signal to replace the ramp shown in FIG. 1. Once the number M is determined, all of the points in Equation (7) can be measured by a step response test, or calculated with the known p(t) function. This data acquisition job is performed once only and the values are saved into a table, or an array [a₁, . . . , a_{M}]. For example, with a constant Tₛ, it can be seen in Equation (10):

a₁=p(Tₛ)

a₂=p(2Tₛ)−p(Tₛ)

a₃=p(3Tₛ)−p(2Tₛ)

.

.

.

a_{M}=p(MTₛ)−p((M−1)Tₛ), Eq. 10

After (tₖ₋₁−tⱼ)≦6Tₑ, the system settles down, and [p(tₖ−tⱼ)−p(tₖ₋₁−tⱼ)]=0. In other words, at time tₖ, only those sampling points that fall into the range of (tₖ₋₁−tⱼ)<6Tₑ are able to contribute to y(tₖ)'s summation term. Thus, Equation (7) becomes Equation (11):

y(tₖ)=y(tₖ₋₁)+a₁Δxₖ₋₁+a₂Δxₖ₋₂+ . . . +a_{M}Δx_{k-M}, Eq. 11

when sample length Tₛ=6Tₑ/M.

Equation (11) is the simplest form for calculating the system response y(t) when there is an arbitrary input signal x(t) at a constant sampling frequency. A more general formula is shown in Equation (12), where the sampling step length, Tₛ, could be varied:

$$y ( {t}_{k} ) = y ( {t}_{k - 1} ) + Δ {x}_{k - 1} p ( {t}_{k} - {t}_{k - 1} ) + {\sum }_{j = n}^{k - 2} Δ {x}_{j} [ p ( {t}_{k} - {t}_{j} ) - p ( {t}_{k - 1} - {t}_{j} ) ] , \qquad Eq . 12$$

where the maximum sample step, max(Tₛ)<Tₑ/2 and (tₖ₋₁−tₙ)<6Tₑ.

Equations (11) and (12) are the time-domain models of an arbitrary LTI system when using 6Tₑ as the preferred settle time period. If enhanced accuracy is desired, one may increase from “6Tₑ” to a higher multiple of Tₑ, for example, 12Tₑ, and may select a larger number for M as well. The importance of Equations (11) and (12) is that they provide alternative iterative modeling methods for calculating the response of an LTI system to an arbitrary input at the arbitrary accuracy required (by selecting M) for simulation of the LTI system, based on the minimal amount of data set. The modeling and simulation systems, algorithms and methods may be implemented in the form of software, hardware, or a combination of hardware and software.

In software implementation, the model is preferably written in a common computer language, such as C, to run on any platform accepting the common language. The model requires only the saved data points of a standard step response, denominated “standard step response data” herein, to iteratively calculate the output y(t) of the system, corresponding to an arbitrary input x(t). The standard step response data may be obtained from known simulation software, bench tests, ideal system estimation, etc., for use with the invention.

FIG. 3 is a block diagram showing an example of the architecture of the iterative model and system 10 of the invention. In a broad-sense, the base-block 12 representing the standard step response data is not required to be a table of the outputinput ratio. It may be an analytical expression of unity step response p(t) (or impulse response) if it is known. Alternatively, the transfer function of the system H(S), may be used. Generally any technique that record and reproduce a step-response will serve. Block 14 represents the application of a modeling equation, preferably Equation 11 or Equation 12 herein. The modeling block 14 receives an arbitrary input 16 and provides an output 18 according to the operations further described herein by using the standard step response 12.

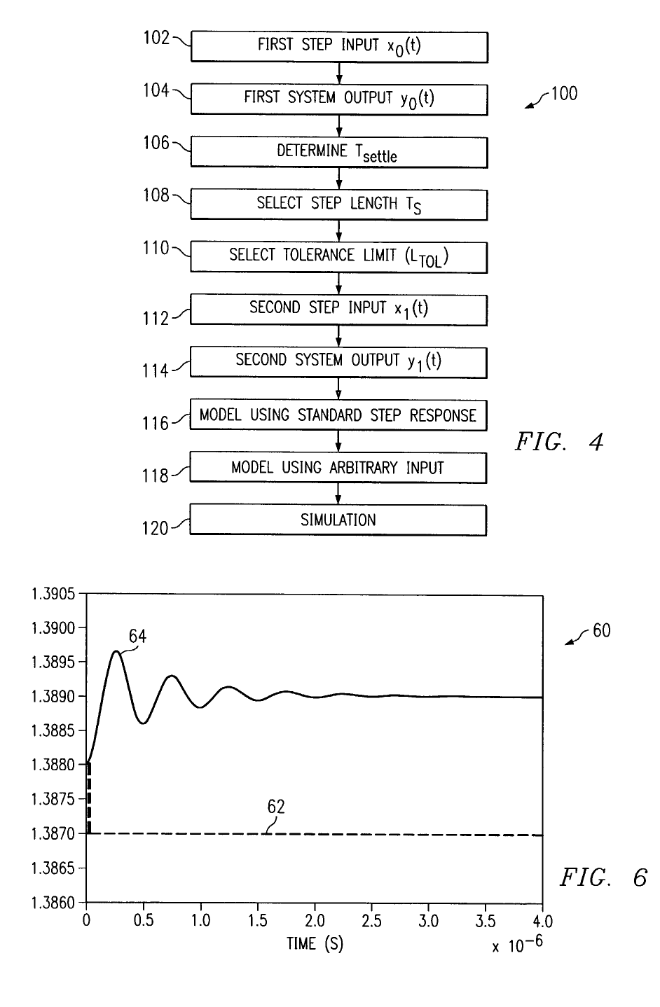

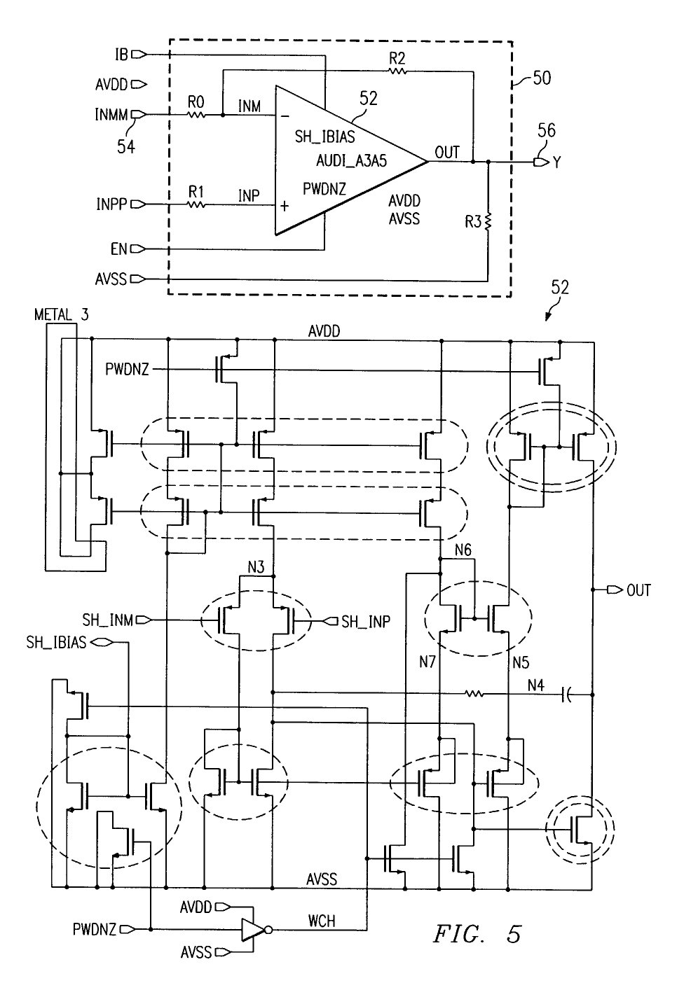

The model discussed has been implemented both in a MatLab (a registered trademark of MathWorks, Inc.,) environment and in PowerMill ADFMI (a registered trademark of Synopsis, Inc.,) for the simulation of 2nd and 3rd order LTI integrated circuits. Many other examples of the implementation of the principles of the invention are possible. FIG. 4 illustrates the steps in general, and FIGS. 5-8 which follow, illustrate an actual example, from which it can be seen that the invention can be used to provide a simulation model with an advantageous reduction in the number of data points needed to produce an accurate simulation. The model thus provided gives rise to numerous additional advantages such as reduced simulation time and computation overhead.

FIG. 4 is a process flow diagram, denoted generally as 100, showing an example of the steps of the invention. Variations and additional steps are possible without departure from the concept of the invention. In step 102, the LTI system is provided with a first step input x₀(t), not necessarily of unity amplitude. As shown in step 104, the first system output, y₀(t), is observed. The system settle time, Tₛₑₜₜₗₑ, is determined by the duration of time measured from when the first input x₀(t) is applied until the time that the first output y₀(t) becomes settled to a substantially constant value. (Step 106).

A sample step length, Tₛ, is provided (step 108) for use in the model and simulation. It should be understood that the sample step length Tₛ, may be fixed or variable. In general, the smaller the step length, Tₛ, the more precise the step response data. Preferably, Tₛ=Tₛₑₜₜₗₑ/M, where M is selected from within the range of about 20 to 500 normally. Of course, the larger the M value, the more accuracy the simulation can attain at the cost of increased simulation time. Shown in step 110, a tolerance limit, L_{TOL}, for error detection in the model is selected. The tolerance limit, L_{TOL}, may be selected according to various operational and design criteria depending on the application. A second step input, x₁(t), is applied to the LTI system, (step 112), and a second system output, y₁(t), signal is measured. (Step 114). The standard system response, preferably the ratio of the second output signal to the second input signal, y₁(t)/x₁(t) measured in step 114, is used in step 116 to model the LTI system, typically using the relationship of Equation (12). Of course, for the special case of a fixed sample step length Tₛ, the relationship of Equation (11) may be used. As indicated at step 118, simulation results for the LTI system are then provided. The simulation results may be displayed in numerical or graphical form, or stored in machine memory known in the arts.

FIG. 5 shows an example of the implementation of the systems and methods of the invention to perform a simulation on a circuit block 50 where a major part of block 50, sub-block circuit 52 consists of many transistors. The first and second input signals are provided at interface 54. The first and second output signals are monitored at output point 56. For the purposes of the simulation steps described with reference to FIG. 4, the circuit block 50 is a “black box” LTI system between the input 54 and output 56. In this particular example, the simulation model is implemented using Equation (12) and an M value of 200. The configuration for the amp is: IB=−5 uA, VDD=5.5V, INPP connected to common mode voltage source Vcom=1.388V, INMM 54 has an arbitrary input with respect to Vcom. Implementation details are not essential to the concept of the invention. It will be understood by those skilled in the arts that various tools for data collection and measuring may be used for implementing the invention.

As an initial input signal, x₀(t), a one millivolt step signal is applied to INMM 54 to obtain the settle time Tₛₑₜₜₗₑ=4 μs for the circuit block 50. A second input signal, x₁(t), also a one millivolt step signal is applied to INMM 54. The output signal, y₁(t), at point 56 is measured to obtain 200 data points relating y_{1(t) to x}₁(t), for a period of 4 μs. The ratio of y₁(t)/x₁(t) is saved as the standard step response data set for the circuit block 50.

FIG. 6 is a plot showing the standard step response data 60 obtained as described with reference to FIGS. 4 and 5, based on the saved 200 data points. The second step input x₁(t) 62 is shown. The resulting output y₁(t) 64 measured (FIG. 4, step 114), in this case based on 200 data points, is saved for modeling the system for arbitrary simulation inputs. It will be understood by those skilled in the arts that this graphical representation of the standard step response data is presented as but one example representative of the standard step response data created for use by the simulation model. Typically, the standard step response data may be stored in electronically-writeable memory for use by the model without the need for creating graphical representation thereof.

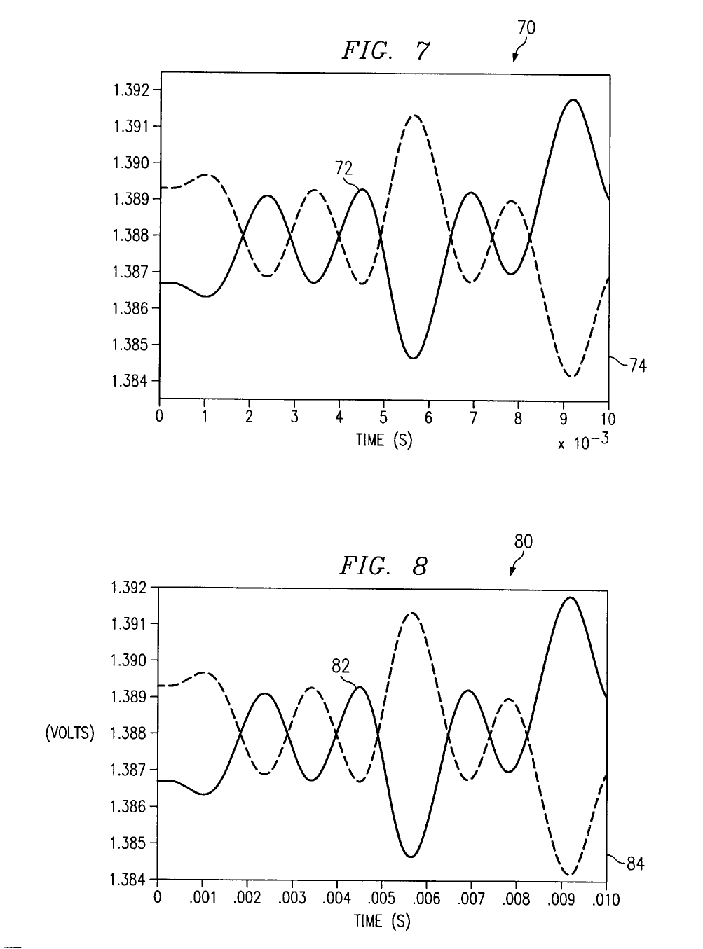

Using the iterative model to complete the simulation of the circuit block 50 using an arbitrary input (not shown). For example employing Equation (12), and the standard step response data, the result shown in FIG. 7 is obtained. FIG. 7 is a graphical representation of a simulation of the particular circuit block 50 of the example shown and described. The simulation results are typically stored in machine-writable memory (not shown).

Understanding of the invention will be enhanced by comparison of FIG. 8 with FIG. 7. FIG. 8 shows an example of a graphical simulation output of circuit block 50 obtained without the use of the invention. As above, the circuit configuration of FIG. 5 including its entire transistors 52 was used with an arbitrary input identical with that used to produce FIG. 7. A conventional transistor-level simulation using Spice was performed, and the output 56 measured as in the example of FIG. 7. The result is shown in FIG. 8. The two results shown in FIGS. 7 and 8 are almost identical, while the block-level simulation of the invention producing FIG. 7 takes much less time than the transistor-level simulation resulting in FIG. 8. Those skilled in the art will recognize that if a more complex analog block were simulated by the simulation model of the invention, the savings in time would be greatly compounded.

Thus the invention provides simulation methods, systems, and algorithms using an iterative method of modeling a LTI system of arbitrary order, using only system standard step response data. By using the system settle time as a criteria to govern data sampling, the invention provides for black-box LTI system simulation that is faster and more adaptable across platforms than previously available in the art. Although the implementation examples shown and described demonstrate results based on a specific application of the invention, they are not intended to limit the scope of the invention. The invention can be implemented using various simulation platforms that provide basic computer language handling. Even though numerous characteristics and advantages of the present invention have been set forth in the foregoing description together with details of the method and device of the invention, the disclosure is illustrative only and changes may be made within the principles of the invention to the full extent indicated by the broad general meaning of the terms used in the attached claims.

I claim:

1. A method of modeling a linear time invariant (LTI) system comprising the steps of:
providing a first step input, x₀(t), to the LTI system for producing a first output, y₀(t);
measuring a settle time, Tₛₑₜₜₗₑ, from the first step input, x₀(t), and the first output, y₀(t);
providing a second step input, x₁(t), to the LTI system for producing a second output, y₁(t);
measuring the second input, x₁(t), and the second output, y₁(t), for a period consisting of the settle time, Tₛₑₜₜₗₑ;
saving the ratio of the second output to the second input, y_{1(t):x}₁(t), as standard step response data; and
modeling the LTI system using the standard step response data.

2. The method according to claim 1 further comprising the step of selecting a tolerance limit, Lₜₒₗ, for error detection in the modeling step.

3. The method according to claim 1 wherein the step of providing LTI system simulation results further comprises the step of displaying the results with a visual display.

4. The method according to claim 1 wherein the step of providing LTI system simulation results further comprises the step of writing the results to a machine-readable memory.

5. The method according to claim 1 wherein the modeling step further comprises the step of modeling a multiple input/multiple output LTI system.

6. The method according to claim 1 wherein the step of measuring the second input, x₁(t), and the second output, y₁(t), for a period consisting of the settle time, Tₛₑₜₜₗₑ, further comprises the step of taking samples at time intervals, Tₛ, described by the formula:
Tₛ=Tₛₑₜₜₗₑ/M,
wherein M consists of a selected accuracy constant.

7. The method according to claim 6 wherein the step of modeling the LTI system using the standard step response data further comprises the step of using the relationship:
$$y ( {t}_{k} ) = y ( {t}_{k - 1} ) + Δ {x}_{k - 1} p ( {t}_{k} - {t}_{k - 1} ) + {\sum }_{k - m}^{k - 2} Δ {x}_{j} [ p ( {t}_{k} - {t}_{j} ) - p ( {t}_{k - 1} - {t}_{j} ) ] ,$$
wherein;
the maximum sample time interval, max(Tₛ)<Tₛₑₜₜₗₑ/2, and;
(tₖ₋₁−t_{k-M})<Tₛₑₜₜₗₑ;

8. The method according to claim 6 wherein the step of modeling the LTI system using the standard step response data further comprises the step of using the relationship:
y(tₖ)=y(tₖ₋₁)+a₁Δxₖ₋₁+a₂Δxₖ₋₂+ . . . +a_{M}Δx_{k-M}, wherein;
sample length Tₛ=Tₛₑₜₜₗₑ/M;

9. The method according to claim 6 wherein the step of modeling the LTI system using the standard step response data further comprises the step of using the relationship:
$$y ( {t}_{k} ) = y ( {t}_{k - 1} ) + Δ {x}_{k - 1} p ( {t}_{k} - {t}_{k - 1} ) + {\sum }_{k - M}^{k - 2} Δ {x}_{j} [ p ( {t}_{k} - {t}_{j} ) - p ( {t}_{k - 1} - {t}_{j} ) ] ,$$
wherein;
the maximum sample time interval, max(Tₛ)<Tₛₑₜₜₗₑ/2, and;
(tₖ₋₁−t_{k-M})<XTₑ, where X consists of a selected system constant and Tₑ consists of a time constant associated with the LTI system.

10. The method according to claim 6 wherein the step of modeling the LTI system using the standard step response data further comprises the step of using the relationship:
y(tₖ)=y(tₖ₋₁)+a₁Δxₖ₋₁+a₂Δxₖ₋₂+ . . . +a_{M}Δx_{k-M}, wherein;
sample length Tₛ=XTₑ/M, where X consists of a selected system constant and Tₑ consists of a time constant associated with the LTI system.

11. A system for constructing a simulation of a linear time invariant (LTI) circuit comprising:
means for determining a settle time, Tₛₑₜₜₗₑ, of the LTI circuit;
means for measuring a step response of the LTI circuit;
means for storing standard step response data of the LTI circuit;
means for modeling the LTI circuit using the standard step response data; and
means for providing LTI circuit simulation results.

12. The system according to claim 11 wherein the standard step response data comprises the ratio of the LTI circuit output, y₁(t), to the LTI circuit input, x₁(t).

13. The system according to claim 11 wherein the means for providing LTI circuit simulation results comprises a visual display.

14. The system according to claim 11 wherein the means for providing LTI circuit simulation results further comprises a machine-readable memory.

15. The system according to claim 11 wherein the means for modeling further comprises means for carrying out the operation:
$$y ( {t}_{k} ) = y ( {t}_{k - 1} ) + Δ {x}_{k - 1} p ( {t}_{k} - {t}_{k - 1} ) + {\sum }_{k - M}^{k - 2} Δ {x}_{j} [ p ( {t}_{k} - {t}_{j} ) - p ( {t}_{k - 1} - {t}_{j} ) ] ,$$
wherein;
x(t)=system input;
y(t)=system output;
a maximum sample time interval, max(Tₛ)<Tₛₑₜₜₗₑ/2; and
(tₖ₋₁−t_{k-M)<XT}ₑ, where X consists of a selected system constant and Tₑ consists of a time constant associated with the LTI system.

16. The system according to claim 11 wherein the means for modeling further comprises means for carrying out the operation:
y(tₖ)=y(tₖ₋₁)+a₁Δxₖ₋₁+a₂Δxₖ₋₂+ . . . +a_{M}Δx_{k-M};
wherein:
x(t)=circuit input;
y(t)=circuit output;
sample time Tₛ=XTₑ/M, where X consists of a selected system constant;
Tₑ consists of a time constant associated with the LTI system; and
M consists of a selected accuracy constant.

17. The system according to claim 11 wherein the means for storing standard step response data of the LTI circuit further comprises nonvolatile electronic memory.

18. The system according to claim 11 wherein the means for modeling the LTI circuit using the standard step response data further comprises at least one Application Specific Integrated Circuit (ASIC).

19. An algorithm for modeling a linear time invariant (LTI) circuit comprising the steps of:
providing a first step input, x₀(t), to the LTI circuit for producing a first output, y₀(t);
measuring a settle time, Tₛₑₜₜₗₑ, from the first step input, x₀(t), and the first output, y₀(t), the settle time being approximately the time interval within which the LTI circuit reaches a steady state;
providing a second step input, x₁(t), to the LTI circuit for producing a second output, y₁(t);
measuring the second input, x₁(t), and the second output, y₁(t), for a period consisting of the settle time, Tₛₑₜₜₗₑ;
saving the ratio of the second output to the second input, y₁(t):x₁(t), as standard step response data;
modeling the LTI circuit using the standard step response data according to the formula:
$$y ( {t}_{k} ) = y ( {t}_{k - 1} ) + Δ {x}_{k - 1} p ( {t}_{k} - {t}_{k - 1} ) + {\sum }_{k - M}^{k - 2} Δ {x}_{j} [ p ( {t}_{k} - {t}_{j} ) - p ( {t}_{k - 1} - {t}_{j} ) ] ,$$
wherein;
a maximum sample time interval, max(Tₛ)<Tₛₑₜₜₗₑ/2, and;
(tₖ₋₁−t_{k-M})<XTₑ, where X consists of a selected system constant.

20. The algorithm according to claim 19 further comprising the setting of a tolerance limit, Lₜₒₗ, for error detection in the model.

21. The algorithm according to claim 19 further comprising the modeling of a multiple input/multiple output LTI system.

22. An algorithm for modeling a linear time invariant (LTI) circuit comprising the steps of:
providing a first step input, x₀(t), to the LTI circuit for producing a first output, y₀(t);
measuring a settle time, Tₛₑₜₜₗₑ, from the first step input, x₀(t), and the first output, y₀(t), the settle time being approximately the time interval required for the LTI circuit to reach a steady state;
providing a second step input, x₁(t), to the LTI circuit for producing a second output, y₁(t);
measuring the second input, x₁(t), and the second output, y₁(t), for a period consisting of the settle time, Tₛₑₜₜₗₑ;
saving the ratio of the second output to the second input, y₁(t):x₁(t), as standard step response data;
modeling the LTI circuit using the standard step response data according to the formula:
y(tₖ)=y(tₖ₋₁)+a₁Δxₖ₋₁+a₂Δxₖ₋₂+ . . . +a_{M}Δx_{k-M}, wherein;
sample length Tₛ=XTₑ/M, where X consists of a selected system constant, Tₑ consists of a time constant associated with the LTI circuit, and M consists of a selected accuracy constant.

23. The algorithm according to claim 22 further comprising the setting of a tolerance limit, Lₜₒₗ, for error detection in the model.

24. The algorithm according to claim 22 further comprising the modeling of a multiple input/multiple output LTI system.
